(19) United States
(12) Patent Application Publication
(10) Pub. No.: US 2017/0192663 A1
(43) Pub. Date: Jul. 6, 2017

(54) TOUCH-BASED LINK INITIALIZATION AND DATA TRANSFER

(71) Applicant: INTEL CORPORATION, Santa Clara, CA (US)

(72) Inventors: WENLONG YANG, Shanghai (CN); TOMER RIDER, Naahryia (IL)

(73) Assignee: Intel Corporation, Santa Clara, CA (US)

(21) Appl. No.: 14/771,823

(22) PCT Filed: Sep. 25, 2014
(86) PCT No.: PCT/CN2014/087443

§ 371 Date: Sep. 1, 2015

(51) Int. Cl. G06F 3/0488; H04W 4/00; H04W 76/02; G06F 3/14

(52) U.S. Cl. CPC G06F 3/04883; G06F 3/1454; H04W 4/008; H04W 76/02

(57) ABSTRACT

This disclosure is directed to touch-based link establishment and data transfer. In one embodiment, a gesture drawn on the surface of a touch-sensitive display may trigger a device to engage in link establishment, to advertise the availability of data to share, to receive shared data etc. The device may also determine if the user triggering the activity is recognized based on a touch area shape of a user's fingertip sensed when the gesture was drawn. For example, the device may compare the gesture drawn on the surface of the display to known gestures to determine the particular activity being requested, and may also compare the touch area shape to known touch area shapes to determine if the user that requested the activity is authorized to make the request, is the same user for all devices participating in the activity, etc.

### TECHNICAL FIELD

The present disclosure relates to communication systems, and more particularly, to a system for link establishment based on gesture recognition and/or touch area identification.

### BACKGROUND

Modem society is increasingly relying upon a multitude of electronic technology for conducting everyday interaction. The usage model has evolved from users typically relying upon a single device (e.g., a wireless cellular handset) to the utilization of a group of devices including, for example, a smart phone, a form of mobile computing such as a tablet computer or laptop, one or more wearable devices, etc. Moreover, it may be desirable to a user to have their group of devices interact with other singular/grouped devices. For example, a user may desire to have their smart phone interact with their automobile infotainment and/or navigation system, their mobile computing device mirror data with their work-based computing solution, etc. In addition, users may want their devices to be interchangeable with the devices of their acquaintances. This means that a married couple's devices interact not only with their own group of devices, but may also be coupled to their spouse's group of devices, their children's group of devices, etc. so that users are not limited to only being able to use their own devices when another device is more convenient, more economical, includes desirable content, etc.

While the benefits of the above interplay are apparent, achieving interoperability of this magnitude is not easy. The configuration of short-range (e.g., within a couple of meters) wireless relationships is neither intuitive nor immediate. A variety of menus may need to be navigated just to initiate the process of link establishment. The devices need to enter a mode allowing at least one of the devices to be found, and then interaction between the devices may commence requiring the user to, for example, manually confirm device identity, confirm the intention of connecting to the other device, manually input data to confirm that both devices are under the control of the user, etc. Finally, after all of this commotion the devices may be wirelessly coupled. The operations required for link establishment may be daunting to novice users that don't have a strong command of the technology, experienced users that don't want to deal with the hassle, etc., and thus, may be prohibitive to setting up wireless connections. The inability to utilize the myriad of functionality associated with wireless communication may result in poor user quality-of-experience, the slower adoption of new technologies, etc.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example of touch-based link initialization in accordance with at least one embodiment of the present disclosure;

FIG. 2 illustrates an example configuration for a device usable in accordance with at least one embodiment of the present disclosure;

FIG. 3 illustrates example operations for touch-based link initialization in accordance with at least one embodiment of the present disclosure;

FIG. 4 illustrates an example of touch-based data transfer in accordance with at least one embodiment of the present disclosure; and

FIG. 5 illustrates example operations for touch-based link initialization in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to touch-based link establishment and data transfer. In one embodiment, a gesture drawn on the surface of a touch-sensitive display may trigger a device to engage in link establishment, to advertise the availability of data to share, to receive shared data etc. The device may also determine if the user triggering the activity is recognized based on a touch area shape of a user's fingertip sensed when the gesture was drawn. For example, the device may compare the gesture drawn on the surface of the display to known gestures to determine the particular activity being requested, and may also compare the touch area shape to known touch area shapes to determine if the user that requested the activity is authorized to make the request, is the same user for all devices participating in the activity, etc. A gesture including an object or a location may be recognized as an instruction to transfer the object or to receive the object into the location. A failure to recognize a gesture or user may result in a failure notification being presented by the device.

In at least one embodiment, a device for touch-based link initialization and data transfer may comprise, for example, a communication module, a display and a touch connect module. The communication module may be to interact with at least one other device. The display may be to present data. The display may include at least one sensor to sense a touch input to a surface of the display and to generate touch data based on the touch input. The touch connect module may be to at least receive touch data from the at least one sensor and to control at least the communication module based on the touch data.

For example, the communication module being to interact with the at least one other device may comprise the communication module being at least to establish a short-range wireless link to the at least one other device. The at least one sensor being to sense a touch input to a surface of the display may comprise the at least one sensor being to sense at least a gesture drawn on the surface of the display. The touch connect module being to control at least the communication module further may comprise the touch connect module being to determine if the gesture corresponds to at least one know gesture, and if determined to correspond to at least one known gesture, to control the communication module based on the gesture. The touch connect module being to control the communication module based on the gesture may comprise the touch connect module being to cause the communication module to transmit a signal inviting wireless link establishment. In at least one embodiment, the touch connect module may further be to cause the display to present a confirmation request prior to allowing the communication module to establish a wireless link. The touch connect module being to control the communication module based on the gesture may also comprise the touch connect module being to cause the communication module to transmit a signal advertising availability of the device to share at least one object. The touch connect module may further be to cause the display to present a confirmation request prior to allowing the communication module to share the at least one object. The touch connect module being to control the communication module based on the gesture may also comprise the touch connect module being to cause the communication module to sense for a signal advertising availability of the at least one other device to share at least one object.

In the same or a different embodiment, the at least one sensor being to sense a touch input to a surface of the display may further comprise the at least one sensor being to sense a touch area shape of a fingertip utilized to draw the gesture. The touch connect module may further be to determine whether the touch area shape corresponds to a known touch shape area, and if it is determined that the touch shape area does not corresponds to a known touch shape area, to prevent the communication module from interacting with the at least on other device. If it is determined that the touch shape area does not correspond to a known touch shape area, the touch connect module may further be to cause the display to present an indication that the touch area shape has not been recognized. A method for touch-based link initialization and data transfer consistent with the present disclosure may comprise, for example, sensing a gesture drawn on a surface of a display in a device, identifying the gesture, sensing a touch area shape associated with the gesture and controlling communications in the device based on the gesture and the touch area shape.

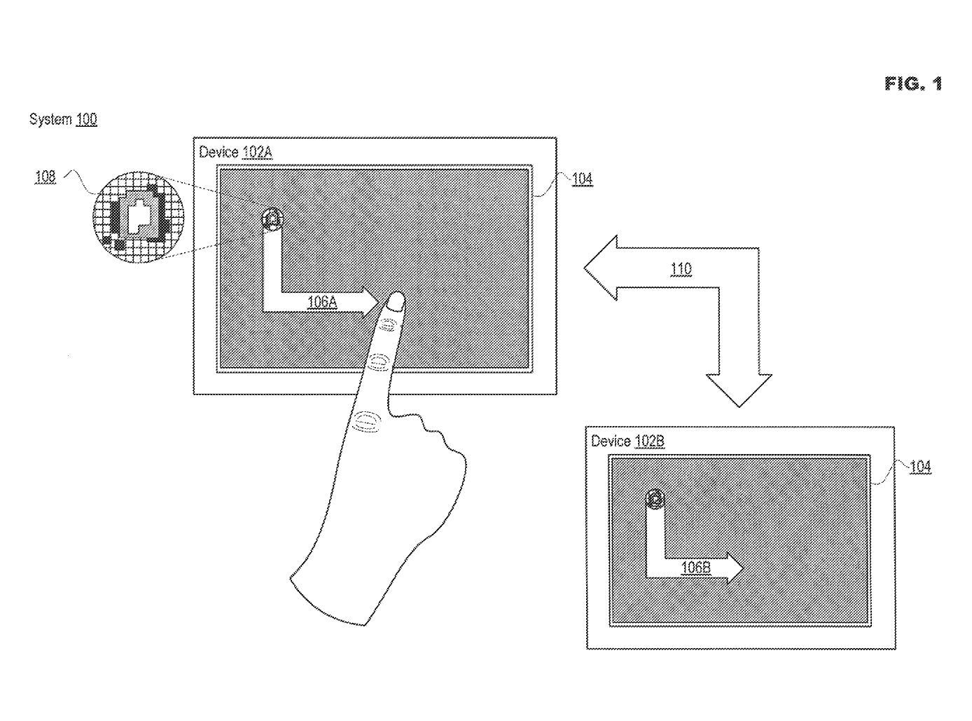

FIG. 1 illustrates an example protection system including machine learning snapshot evaluation in accordance with at least one embodiment of the present disclosure. System 100 has been illustrated in FIG. 1 as comprising device 102A and device 102B. Only two devices have been disclosed in system 100 to ensure clarity when describing embodiments consistent with the present disclosure. However, the operations described in FIG. 1 may occur between more than just two devices depending on, for example, the capabilities of the communication resources in each device, the number of devices needed to support a certain activity, etc.

In practice, devices 102A and 102B may be any electronic device that comprises at least some form of data processing ability and a touch screen interface. Examples of devices 102A and 102B may comprise, but are not limited to, a mobile communication device such as cellular handsets, smartphones, etc. based on the Android® operating system (OS) from the Google Corporation, iOS® from the Apple Corporation, Windows® OS from the Microsoft Corporation, Mac OS from the Apple Corporation, Tizen™ OS from the Linux Foundation, Firefox® OS from the Mozilla Project, Blackberry® OS from the Blackberry Corporation, Palm™ OS from the Hewlett-Packard Corporation, Symbian® OS from the Symbian Foundation, etc., mobile computing devices such as tablet computers like an iPad® from the Apple Corporation, Surface® from the Microsoft Corporation, Galaxy Tab® from the Samsung Corporation, Kindle Fire® from the Amazon Corporation, etc., Ultrabooks® including a low-power chipset manufactured by Intel Corporation, netbooks, notebooks, laptops, palmtops, etc., wearable devices such as wristwatch form factor computing devices like the Galaxy Gear® from Samsung, eyewear form factor interfaces like Google Glass® from the Google Corporation, etc., typically stationary computing devices such as desktop computers with or without an integrated monitor, servers, smart televisions, small form factor computing solutions (e.g., for space-limited computing applications, TV set-top boxes, etc.) like the Next Unit of Computing (NUC) platform from the Intel Corporation, etc.

In at least one embodiment, device 102A may comprise display 104 that is touch-sensitive. Display 104 may be based on various display technologies such as, but not limited to, cathode ray tube (CRT), liquid crystal display (LCD), plasma, light emitting diode (LED), active-matrix organic LED (AMOLED), Retina® from the Apple Corporation, etc. Display 104 may be configured to present at least one image to a user of device 102A. Examples of an image may comprise a typical graphical desktop including applications, windows, icons, widgets, etc. To support touch sensing, display 104 may include at least one sensor operating as a standalone component used in conjunction with display 104, or alternatively, some or all of the sensor may be integrated within display 104. The sensor may employ various sensing technologies to detect when the surface of display 104 is touched (e.g., by a finger) such as, but not limited to, visible (e.g., image capture-based, photoelectric, etc.), electromagnetic (e.g., Hall Effect), electronic (e.g., capacitive), infrared (IR), etc. Regardless of the particular technology that is used, the sensor may be capable of sensing, for example, a touch location (e.g., coordinates) of a finger on the surface of display 104, a change in location occurring due to the finger moving across the surface (e.g., to draw a gesture), touch-related pressure, touch-related temperature, a touch area shape 108 corresponding to the user's fingertip, etc.

An example of touch area shape sensing is disclosed at 108 in FIG. 1. For example, the sensor may sense actual contact between a user's finger and the surface and may map the contact to formulate a touch area shape. The sensor data may then be processed, filtered, etc. to remove extraneous data (e.g., noise). The resulting data may be a mapping of the contact between the fingertip and surface using a grid system (e.g., based on pixel units, metric units, English units, etc.). The lightest interior potion of touch area shape 108 may correlate to, for example, definite finger/surface contact while the darker shaded areas may correlate to lower probability contact and/or possible noise. Similar to a fingerprint, touch area shape 108 may be unique for different fingers of the same person, between different people, etc. After touch area shape 108 is sensed for a user, it may be recorded and used to, for example, confirm that the particular user is the person who touched the surface of display 104 (e.g., by comparing a currently measured touch area shape 108 to a previously recorded touch area shape 108). Touch area shape 108 may also be communicated between different devices to verify that, for example, a user touching device 102A is the same user touching display 104 in device 102B.

In an example of operation, a user may use a finger to touch the surface of display 104 in device 102A and may move the finger to draw gesture 106A. Device 102A may determine whether gesture 106A is a known gesture. For the sake of explanation herein, gesture 106A may instruct device 102A to transmit a signal inviting link establishment. The user may then proceed to draw gesture 106B on the surface of display 104 in device 102B. It is important to note that while gestures 106A and 106B are represented as being similar, this similarity is not required. Gestures 106A and 106B may be made up of similar finger movements, or may be completely different to indicate, for example, different operations in devices 102A and 102B (e.g., advertising device availability vs. scanning for a device availability signal, sharing an object vs. receiving a shared object, etc.).

Given that device 102A is able to determine that gesture 106A is known, devices 102A and/or 102B may make a further determinations as to whether touch area shape 108 is known. The touch area shape determination may be made to ensure that an authorized user is inputting gestures 106A and 106B, that the same user input gestures 106A and 106B, etc. In one embodiment, part of the link invitation signal broadcast by device 102A may include the mapping of touch area shape 108. Thus, when device 102B receives a link invitation signal including the mapping of touch area shape 108, it may use the mapping to verify that the user that initiated link establishment in device 102A is the user now interacting with device 102B. If gestures 106A and 106B are recognized in devices 102A and 102B, respectively, and touch area shape 108 is also recognized (e.g., depending on the configuration of system 100), then the operation(s) corresponding to gestures 106A and 106B may be executed in devices 102A and 102B, which may include, for example, wireless link establishment as shown at 110.The operations utilized in establishing wireless link 110 between at least devices 102A and 102B may depend upon the particular wireless protocol in use. For example, if Bluetooth is being employed, then link establishment operations may include device “pairing” as is typical with Bluetooth. It is important to note that, while the embodiments disclosed herein are primarily focused on communication-related operations, device-to-device wireless interaction is merely a readily comprehensible scenario useful for explaining relevant systems, methods, teachings, etc. The systems, methods and teachings may also be used to control other device operations.

At least one benefit that may be realized from the operations disclosed in FIG. 1 is that wireless link establishment may be carried out in a secure manner without the need for any manual configuration. A simple gesture 106A or 106B drawn on the surface of display 104 in device 102A or 102B may not only carry out the desired link establishment, but may do so only at the request of a user that is qualified to request such an operation. Moreover, it may also be possible to automate the recording of touch area shape 108 in device 102A. In one embodiment, upon the initial activation of device 102A the new owner of device 102A may be requested to draw a calibration gesture 106A on the surface of display 104, allowing the owner's touch area shape 108 to be recorded. Updates to touch area shape 108 may then be made via menu-based configuration, by drawing another calibration gesture 106A, etc.

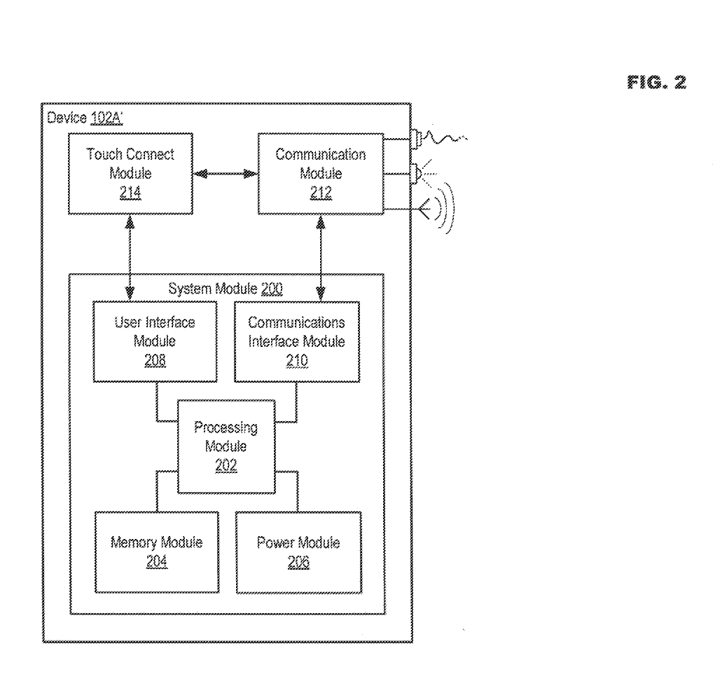

FIG. 2 illustrates an example configuration for device 102A′ in accordance with at least one embodiment of the present disclosure. In particular, device 102A′ may be capable of performing example functionality such as disclosed in FIG. 1. However, device 102A′ is meant only as an example of equipment usable in embodiments consistent with the present disclosure, and is not meant to limit these various embodiments to any particular manner of implementation. The example configuration of device 102A′ illustrated in FIG. 2 may also be applicable to device 102B also disclosed in FIG. 1.

Device 102A′ may comprise, for example,system module 200 configured to manage device operations. System module 200 may include, for example, processing module 202, memory module 204, power module 206, user interface module 208 and communication interface module 210. Device 102A′ may further include communication module 212 and touch connect module 214. While communication module 212 and touch connect module 214 have been illustrated as separate from system module 200, the example implementation shown in FIG. 2 has been provided herein merely for the sake of explanation. For example, some or all of the functionality associated with communication module 212 and/or touch connect module 214 may be incorporated in system module 200.

In device 102A′, processing module 202 may comprise one or more processors situated in separate components, or alternatively one or more processing cores embodied in a single component (e.g., in a System-on-a-Chip (SoC) configuration), along with any relevant processor-related support circuitry (e.g., bridging interfaces, etc.). Example processors may include, but are not limited to, various x86-based microprocessors available from the Intel Corporation including those in the Pentium, Xeon, Itanium, Celeron, Atom, Core i-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in device 102A′. Some or all of the functionality commonly associated with the support circuitry may also be included in the same physical package as the processor (e.g., such asin the Sandy Bridge family of processors available from the Intel Corporation).

Processing module 202 may be configured to execute various instructions in device 102A′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) or read-only memory (ROM) in a fixed or removable format. RAM may include volatile memory configured to hold information during the operation of device 102A′ such as, for example, static RAM (SRAM) or Dynamic RAM (DRAM). ROM may include non-volatile (NV) memory modules configured based on BIOS, UEFI, etc. to provide instructions when device 102A′ is activated, programmable memories such as electronic programmable ROMs (EPROMS), Flash, etc. Other fixed/removable memory may include, but are not limited to, magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power module 206 may include internal power sources (e.g., a battery, fuel cell, etc.) and/or external power sources (e.g., electromechanical or solar generator, power grid, fuel cell, etc.), and related circuitry configured to supply device 102A′ with the power needed to operate. User interface module 208 may include equipment and/or software to allow users to interact with device 102A′ such as, for example, various input mechanisms (e.g., microphones, switches, buttons, knobs, keyboards, speakers, touch-sensitive surfaces (e.g., display 104), one or more sensors configured to capture images and/or sense proximity, distance, motion, gestures, orientation, etc.) and various output mechanisms (e.g., speakers, displays, lighted/flashing indicators, electromechanical components for vibration, motion, etc.). The equipment in user interface module 208 may be incorporated within device 102A′ and/or may be coupled to device 102A′ via a wired or wireless communication medium.

Communication interface module 210 may be configured to manage packet routing and other control functions for communication module 212, which may include resources configured to support wired and/or wireless communications. In some instances, device 102A′ may comprise more than one communication module 212 (e.g., including separate physical interface modules for wired protocols and/or wireless radios) all managed by a centralized communication interface module 210. Wired communications may include serial and parallel wired mediums such as, for example, Ethernet, Universal Serial Bus (USB), Firewire, Thunderbolt, Digital Video Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), etc.), short-range wireless mediums (e.g., Bluetooth, WLAN, Wi-Fi, etc.), long range wireless mediums (e.g., cellular wide-area radio communication technology, satellite-based communications, etc.) or electronic communications via sound waves. In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission. While the embodiment disclosed in FIG. 2 illustrates communication interface module 210 being separate from communication module 212, it may also be possible for the functionality of communication interface module 210 and communication module 212 to be incorporated within the same module.

In the example disclosed in FIG. 2, touch connection module 214 may interact with at least user interface module 208 and communication module 212. In an example of operation, a user may provide touch input to display 104 in user interface module 208. The touch input may generate touch data in user interface module 208. Touch data may include, for example, raw coordinate data, pressure data, temperature data, etc. generated by the touch input and/or processed touch data including gesture data 106A, touch area shape data 108, etc. The touch data may then be provided to touch connect module 214 for processing. The processing of the touch data may include, for example, the generation of gesture 106A and/or touch area shape data 108 from raw data, a determination if gesture 106A and/or touch area shape data 108 is recognized, etc. Touch connect module 214 may then interact with communication module 212 to, for example, cause communication module to transmit a signal inviting link establishment, scan for a signal from another device inviting link establishment, transmit a signal advertising the availability of device 102B to share an object, scan for another device advertising the availability to share an object or another communication-related operation.

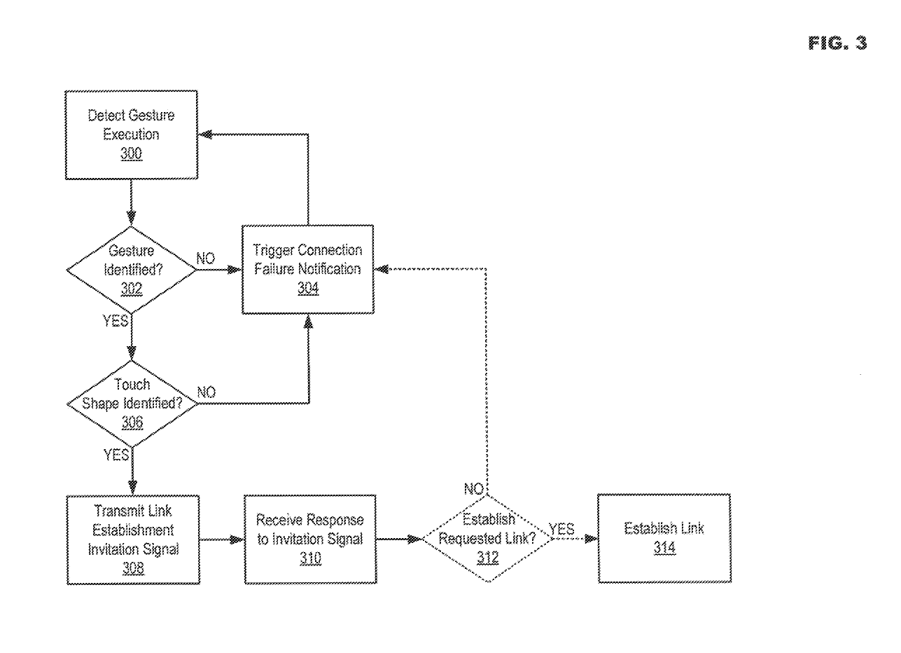

FIG. 3 illustrates example operations for touch-based link initialization in accordance with at least one embodiment of the present disclosure. In operation 300, a device may detect a gesture being executed (e.g., detect a user's fingertip drawing a gesture on the surface of a display). A determination may then be made in operation 302 as to whether the gesture may be identified as a known gesture. If it is determined in operation 302 that the gesture cannot be identified, then in operation 304 a failure notification may be triggered in the device. The failure notification may include, for example, a visible and/or audible alert indicating to the user of the device that the gesture is not recognized. If in operation 302 it is determined that the gesture has been recognized, then in operation 306 a further determination may be made as to whether the touch area shape of the user's finger may be identified as a known touch area shape. A determination that the touch area shape cannot be identified in operation 306 may be followed by a return to operation 304 wherein a failure notification may be triggered indicating to the user that the touch area shape of the user's fingertip cannot be identified.

If in operation 306 the touch area shape is identified, then in operation 308 a link establishment invitation signal may be transmitted. In operation 310 a response may be received from another device, the response requesting to establish a wireless link. Operation 312 may be optional in that it provides an extra layer of security prior to link establishment, but is not necessary for all embodiments. For example, operation 312 may be preferable in an environment wherein at least some of the devices to which links may be established are not known, unfamiliar, etc. A determination may be made in operation 312 as to whether a wireless link should be established with the responding device. In at least one embodiment, the determination of operation 312 may include the display of the device presenting a user interface to the user, the user interface including controls (e.g., graphical buttons) allowing the user of the device to abort link establishment. A determination that a link should not be established in operation 312 may be followed by a return to operation 304 wherein a failure notification may be triggered indicating to the user that link establishment has been aborted. A determination in operation 312 that a link should be established may be followed by operation 314 wherein link establishment may proceed. As set forth above, the operations involved in link establishment may depend on the wireless protocol being utilized.

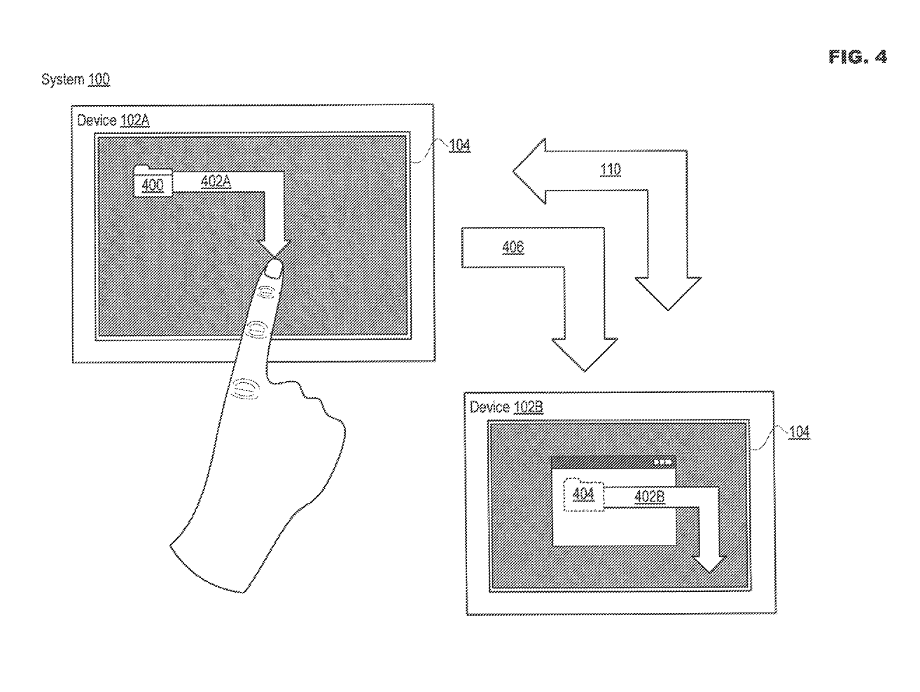

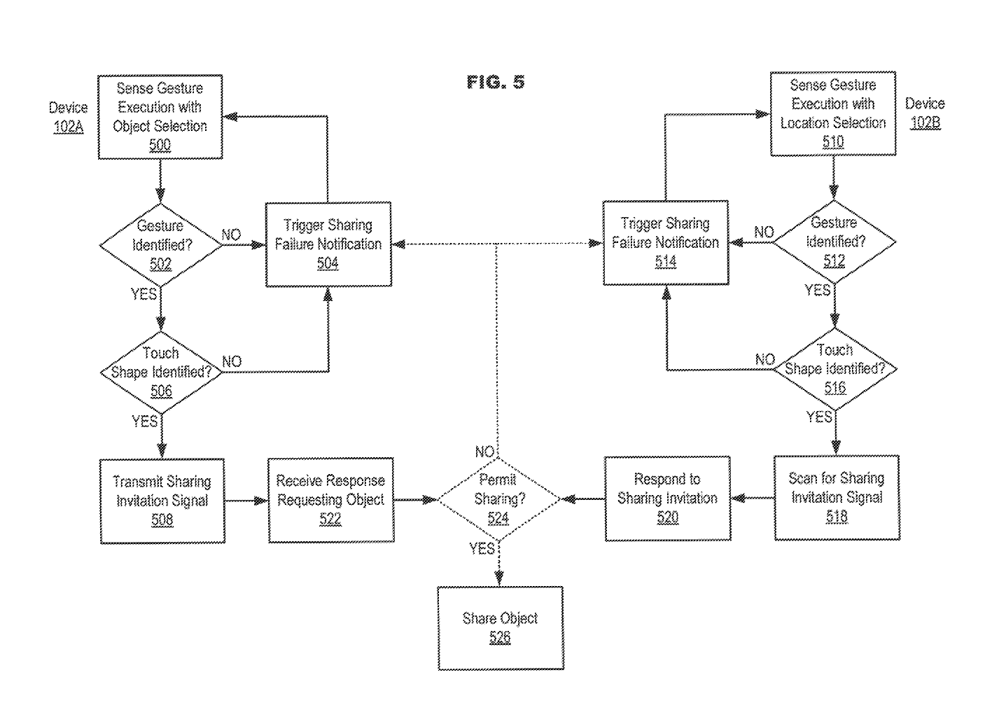

FIG. 4 illustrates an example of touch-based data transfer in accordance with at least one embodiment of the present disclosure. System 100 is again shown in FIG. 4, but in this example a user of device 102A may desire to share object 400 with (e.g., transmit a copy of object 400 to) device 102B. Object 400 may be data including, for example, an application, file, folder, zip container, etc. In at least one embodiment, a user may perform operations such as described in FIGS. 1 and 3 to first establish wireless link 110 prior to executing the operations disclosed in FIGS. 4 and 5 to share object 400. In another embodiment, the user executing the operations described in FIGS. 4 and 5 may both establish wireless link 110 and also cause object 400 to be shared. The user may initiate sharing by drawing gesture 402A on the surface of display 104 in device 102A. Gesture 402A may comprise object 400 (e.g., may initiate at the coordinate location of object 400, cross over the coordinate location of object 400, end at the coordinate location of object 400, etc.) so as to identify object 400 as the object to be shared. It is important to note that while gesture 402A is illustrated as being drawn in a different manner than gesture 106A, gestures 402A and 106A may be drawn in the same manner with gesture 402A merely including object 400 to indicate a sharing operation.

The user may then draw gesture 402B on the surface of display 104 in device 102B. Gesture 402B may include the visual depiction of location 404 within device 102B in which object 400 should be placed. While gesture 402B has been represented as being drawn in the same manner as gesture 402A, this is merely for the sake of explanation. Gesture 402B may be drawn in a wholly different manner to, for example, indicate to device 102B that it should enter a mode to receive object 400 for another device. For example, the execution of gesture 402B may comprise the same shape being drawn on the surface of display 104 with location 404 being indicated by coordinates on display 104 where gesture 402B is concluded instead of the display coordinates where gesture 402B was initiated (as shown). Otherwise, gesture 402B may include a drawing of various shapes such as, for example, a circle around location 404, a square around location 404, a zigzag starting or ending at location 404, etc. In at least one embodiment, location 404 may not be identified as part of the execution of gesture 402B, but execution of gesture 402B may instead trigger the presentation of a user interface asking the user to select location 404. Similar to the example disclosed in FIG. 1, devices 102A and 102B may then identify gestures 402A and 402B, respectively, and may, depending on the configuration of devices 102A and 102B, identify touch area shape 108. If gestures 402A and 402B are determined to be known gestures for sharing an object, and touch area shape 108 is determined to be recognized, then device 102A may transmit object 400 to device 102B as shown at 406, device 102B storing object 400 at location 404.

FIG. 5 illustrates example operations for touch-based link initialization in accordance with at least one embodiment of the present disclosure. Operations 500 to 508 may occur on a device sharing an object (e.g., device 102A). In operation 500, gesture execution may be sensed, the gesture execution including the selection of an object to share. Similar to the example disclosed in FIG. 3, operations 502, 504 and 506 may include determinations of whether the gesture sensed in operation 500 was identified and whether the touch area shape of the user's finger that drew the gesture was recognized. If either determination fails in operation 502 or 506, then in operation 504 a sharing failure notification may be triggered, the failure sharing notification including a visible and/or audible alert indicating that sharing has failed. If positive determinations are made in operations 502 and 506, then in operation 508 a signal may be transmitted advertising the availability of the device to share the object.

Operations 510 to 518 may occur on a device receiving a shared object (e.g., device 102B). In operation 510, gesture execution may be sensed, the gesture execution including the selection of a location in which to store an object shared from another device (e.g., device 102A). Similar to operations 502 to 506 that occurred in device 102A, operations 512 to 516 may include determinations of whether the gesture sensed in operation 510 was identified and whether the touch area shape of the user's finger that drew the gesture was recognized. Again, if either determination fails in operation 512 or 516, then in operation 514 a sharing failure notification may be triggered, the failure sharing notification including a visible and/or audible alert indicating that sharing has failed. If the determinations in operations 512 and 516 are “YES,” then in operation 518 scanning for a sharing invitation signal transmitted by device 102A may start. Upon scanning the sharing invitation signal transmitted from device 102A, a response may be transmitted from device 102B to device 102A in operation 520.

The response that was transmitted from device 102B may be received in device 102 in operation 522. An optional determination may then be made on one or both devices 102A or 102B as to whether to permit sharing in operation 524. Operation 524 may not be necessary for all embodiments, and may depend on, for example, whether devices 102A and 102B are familiar to each other (e.g., devices 102A and 102B are owned by the same user, the users of devices 102A and 102B are related, previously acquainted, etc.). In at least one embodiment, the determination of operation 524 may include the displays of one or both devices 102A or 102B presenting user interfaces to the user(s), the user interfaces including controls (e.g., graphical buttons) allowing the user(s) to abort sharing. A determination in operation 524 that sharing should not be permitted (e.g., triggered by user interaction with either device 102A or 102B) may be followed by a return to operations 504 and 514 in devices 102A and 102B, respectively, to trigger sharing failure notifications indicating that object sharing has been aborted. If in operation 524 it is determined that the object transfer is permitted, then in operation 526 the object may be shared (e.g., transmitted from device 102A to device 102B).

In at least one embodiment, it may be possible for devices 102A and 102B to switch roles to facilitate sharing. A role switch may be triggered by an event such as, for example, the expiration of a certain time period. For example, following operation 506, device 102A may start transmitting a sharing invitation signal in operation 508. Similarly, after operation 516, device 102B may initiate scanning for the sharing invitation signal transmitted by device 102A in operation 518. However, if device 102B does not scan the sharing invitation signal transmitted by device 102A (e.g., after the certain time period), then device 102B may change modes and, for example,start scanning for sharing invitation signals from other devices, or may start transmitting its own sharing invitation signal. Failing to receive a response to the sharing invitation signal in operation 522 (e.g., after the certain period of time) may likewise cause device 102A to stop transmission of the sharing invitation signal and change modes to start scanning for sharing invitation signals (e.g., from device 102B). In this manner, sharing may proceed in the event that the originally-conceived sharing scenario becomes unavailable. If after several attempts a connection is not made to at least one other device (e.g., even after role switching as described above), then the sharing operations may terminate automatically.

While FIGS. 3 and 5 may illustrate operations according to different embodiments, it is to be understood that not all of the operations depicted in FIGS. 3 and 5 are necessary for other embodiments. Indeed, it is fully contemplated herein that in other embodiments of the present disclosure, the operations depicted in FIGS. 3 and 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the term “module” may refer to software, firmware and/or circuitry configured to perform any of the aforementioned operations. Software may be embodied as a software package, code, instructions, instruction sets and/or data recorded on non-transitory machine readable storage mediums. Firmware may be embodied as code, instructions or instruction sets and/or data that are hard-coded (e.g., nonvolatile) in memory devices.“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to touch-based link establishment and data transfer. In one embodiment, a gesture drawn on the surface of a touch-sensitive display may trigger a device to engage in link establishment, to advertise the availability of data to share, to receive shared data etc. The device may also determine if the user triggering the activity is recognized based on a touch area shape of a user's fingertip sensed when the gesture was drawn. For example, the device may compare the gesture drawn on the surface of the display to known gestures to determine the particular activity being requested, and may also compare the touch area shape to known touch area shapes to determine if the user that requested the activity is authorized to make the request, is the same user for all devices participating in the activity, etc.

The following examples pertain to further embodiments. The following examples of the present disclosure may comprise subject material such as a device, a method, at least one machine readable medium for storing instructions that when executed cause a machine to perform acts based on the method, means for performing acts based on the method and/or a protection system for touch-based link establishment and data transfer, as provided below.

According to example 1 there is provided a device for touch-based link initialization and data transfer. The device may comprise a communication module to interact with at least one other device, a display to present data, the display including at least one sensor to sense a touch input to a surface of the display and to generate touch data based on the touch input and a touch connect module to at least receive touch data from the at least one sensor and to control at least the communication module based on the touch data.

Example 2 may include the elements of example 1, wherein the communication module being to interact with the at least one other device comprises the communication module being at least to establish a short-range wireless link to the at least one other device.

Example 3 may include the elements of example 2, wherein the short-range wireless link employs at least one of Bluetooth wireless communication or Wireless Local Area Networking.

Example 4 may include the elements of any of examples 1 to 3, wherein the at least one sensor being to sense a touch input to a surface of the display comprises the at least one sensor being to sense at least a gesture drawn on the surface of the display.

Example 5 may include the elements of example 4, wherein the touch connect module being to control at least the communication module further comprises the touch connect module being to determine if the gesture corresponds to at least one known gesture, and if determined to correspond to at least one known gesture, to control the communication module based on the gesture.

Example 6 may include the elements of example 5, wherein the touch connect module being to control the communication module based on the gesture comprises the touch connect module being to cause the communication module to transmit a signal inviting wireless link establishment.

Example 7 may include the elements of example 5, wherein the touch connect module is further to cause the display to present a confirmation request prior to allowing the communication module to establish a wireless link.

Example 8 may include the elements of example 5, wherein the touch connect module being to control the communication module based on the gesture comprises the touch connect module being to cause the communication module to transmit a signal advertising availability of the device to share at least one object.

Example 9 may include the elements of example 8, wherein the at least one object is presented on the display and the gesture indicates the at least one object by at least one of starting on the at least one object, passing through the at least one object or ending on the at least one object.

Example 10 may include the elements of example 8, wherein the touch connect module is further to cause the display to present a confirmation request prior to allowing the communication module to share the at least one object.

Example 11 may include the elements of example 5, wherein the touch connect module being to control the communication module based on the gesture comprises the touch connect module being to cause the communication module to sense for a signal advertising availability of the at least one other device to share at least one object.

Example 12 may include the elements of example 11, wherein a location in which to store the at least one object is presented on the display and the gesture indicates the location object by at least one of starting on the location, passing through the location or ending on the location.

Example 13 may include the elements of example 4, wherein the at least one sensor being to sense a touch input to a surface of the display further comprises the at least one sensor being to sense a touch area shape of a fingertip utilized to draw the gesture.

Example 14 may include the elements of example 13, wherein the touch connect module is further to determine whether the touch area shape corresponds to a known touch shape area, and if it is determined that the touch shape area does not corresponds to a known touch shape area, to prevent the communication module from interacting with the at least on other device.

Example 15 may include the elements of example 13, wherein if it is determined that the touch shape area does not correspond to a known touch shape area, the touch connect module is further to cause the display to present an indication that the touch area shape has not been recognized.

According to example 16 there is provided a method for touch-based link initialization and data transfer. The method may comprise sensing a gesture drawn on a surface of a display in a device, identifying the gesture, sensing a touch area shape associated with the gesture and controlling communications in the device based on the gesture and the touch area shape.

Example 17 may include the elements of example 16, wherein identifying the gesture comprises determining if the gesture corresponds to a known gesture for controlling how the device interacts with at least one other device.

Example 18 may include the elements of example 17, and may further comprise determining that the gesture corresponds to a known gesture and causing the device to transmit at least one of a signal inviting wireless link establishment or a signal advertising availability of the device to share at least one object.

Example 19 may include the elements of any of examples 17 to 18, and may further comprise determining that the gesture corresponds to a known gesture and causing the device to transmit a signal inviting wireless link establishment.

Example 20 may include the elements of any of examples 17 to 18, and may further comprise determining that the gesture corresponds to a known gesture and causing the device to transmit a signal advertising availability of the device to share at least one object.

Example 21 may include the elements of example 20, wherein the at least one object is presented on the display and the gesture indicates the at least one object by at least one of starting on the at least one object, passing through the at least one object or ending on the at least one object.

Example 22 may include the elements of example 20, and may further comprise, if a response is not received to the signal advertising the availability of the device to share the at least one object after a time period, causing the device to stop transmitting the advertising signal and start scanning for a signal requesting the at least one object be shared.

Example 23 may include the elements of any of examples 17 to 18, and may further comprise determining that the gesture corresponds to a known gesture and causing the device to scan for a signal advertising availability of the at least one other device to share at least one object.

Example 24 may include the elements of example 23, wherein a location in which to store the at least one object is presented on the display and the gesture indicates the location object by at least one of starting on the location, passing through the location or ending on the location.

Example 25 may include the elements of example 23, and may further comprise, if a signal advertising the availability of the at least one other device to share the at least one object is not scanned after a time period, causing the device to stop scanning for the advertising signal and start transmitting a signal requesting the at least one object be shared.

Example 26 may include the elements of any of examples 17 to 18, and may further comprise causing the device to present a confirmation request prior to allowing the device to interact with the at least one other device.

Example 27 may include the elements of any of examples 16 to 18, wherein the touch area shape corresponds to an area of a fingertip used to draw the gesture.

Example 28 may include the elements of example 27, and may further comprise determining if the touch shape area corresponds to a known touch shape area, preventing the device from communicating if the touch shape area does not correspond to a known touch shape area and causing the device to present an indication that the touch area shape has not been recognized if the touch shape area does not correspond to a known touch shape area.

According to example 29 there is provided a system including at least two devices, the system being arranged to perform the method of any of the above examples 16 to 28.

According to example 30 there is provided a chipset arranged to perform the method of any of the above examples 16 to 28.

According to example 31 there is provided at least one machine readable medium comprising a plurality of instructions that, in response to be being executed on a computing device, cause the computing device to carry out the method according to any of the above examples 16 to 28.

According to example 32 there is provided at least one device for touch-based link initialization and data transfer, the at least one device being arranged to perform the method of any of the above examples 16 to 28.

According to example 33 there is provided a system for touch-based link initialization and data transfer. The system may comprise means for sensing a gesture drawn on a surface of a display in a device, means for identifying the gesture, means for sensing a touch area shape associated with the gesture and means for controlling communications in the device based on the gesture and the touch area shape.

Example 34 may include the elements of example 33, wherein the means for identifying the gesture comprise means for determining if the gesture corresponds to a known gesture for controlling how the device interacts with at least one other device.

Example 35 may include the elements of example 34, and may further comprise means for determining that the gesture corresponds to a known gesture and means for causing the device to transmit a signal inviting wireless link establishment.

Example 36 may include the elements of any of examples 34 to 35, and may further comprise means for determining that the gesture corresponds to a known gesture and means for causing the device to transmit a signal advertising availability of the device to share at least one object.

Example 37 may include the elements of any of examples 34 to 35, and may further comprise means for determining that the gesture corresponds to a known gesture and means for causing the device to scan for a signal advertising availability of the at least one other device to share at least one object.

Example 38 may include the elements of any of examples 34 to 35, and may further comprise means for causing the device to present a confirmation request prior to allowing the device to interact with the at least one other device.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-25. (canceled)

26. A device for touch-based link initialization and data transfer, comprising:
a communication module to interact with at least one other device;
a display to present data, the display including at least one sensor to sense a touch input to a surface of the display and to generate touch data based on the touch input; and
a touch connect module to at least receive touch data from the at least one sensor and to control at least the communication module based on the touch data.

27. The device of claim 26, wherein the communication module being to interact with the at least one other device comprises the communication module being at least to establish a short-range wireless link to the at least one other device.

28. The device of claim 26, wherein the at least one sensor being to sense a touch input to a surface of the display comprises the at least one sensor being to sense at least a gesture drawn on the surface of the display.

29. The device of claim 28, wherein the touch connect module being to control at least the communication module further comprises the touch connect module being to determine if the gesture corresponds to at least one known gesture, and if determined to correspond to at least one known gesture, to control the communication module based on the gesture.

30. The device of claim 29, wherein the touch connect module being to control the communication module based on the gesture comprises the touch connect module being to cause the communication module to transmit a signal inviting wireless link establishment.

31. The device of claim 29, wherein the touch connect module is further to cause the display to present a confirmation request prior to allowing the communication module to establish a wireless link.

32. The device of claim 29, wherein the touch connect module being to control the communication module based on the gesture comprises the touch connect module being to cause the communication module to transmit a signal advertising availability of the device to share at least one object.

33. The device of claim 32, wherein the touch connect module is further to cause the display to present a confirmation request prior to allowing the communication module to share the at least one object.

34. The device of claim 29, wherein the touch connect module being to control the communication module based on the gesture comprises the touch connect module being to cause the communication module to sense for a signal advertising availability of the at least one other device to share at least one object.

35. The device of claim 28, wherein the at least one sensor being to sense a touch input to a surface of the display further comprises the at least one sensor being to sense a touch area shape of a fingertip utilized to draw the gesture.

36. The device of claim 35, wherein the touch connect module is further to determine whether the touch area shape corresponds to a known touch shape area, and if it is determined that the touch shape area does not corresponds to a known touch shape area, to prevent the communication module from interacting with the at least on other device.

37. The device of claim 36, wherein if it is determined that the touch shape area does not correspond to a known touch shape area, the touch connect module is further to cause the display to present an indication that the touch area shape has not been recognized.

38. A method for touch-based link initialization and data transfer, comprising:
sensing a gesture drawn on a surface of a display in a device;
identifying the gesture;
sensing a touch area shape associated with the gesture; and
controlling communications in the device based on the gesture and the touch area shape.

39. The method of claim 38, wherein identifying the gesture comprises determining if the gesture corresponds to a known gesture for controlling how the device interacts with at least one other device.

40. The method of claim 39, further comprising:
determining that the gesture corresponds to a known gesture; and
causing the device to transmit a signal inviting wireless link establishment.

41. The method of claim 39, further comprising:
determining that the gesture corresponds to a known gesture; and
causing the device to transmit a signal advertising availability of the device to share at least one object.

42. The method of claim 39, further comprising:
determining that the gesture corresponds to a known gesture; and
causing the device to scan for a signal advertising availability of the at least one other device to share at least one object.

43. The method of claim 39, further comprising:
causing the device to present a confirmation request prior to allowing the device to interact with the at least one other device.

44. The method of claim 38, further comprising:
determining if the touch shape area corresponds to a known touch shape area;
preventing the device from communicating if the touch shape area does not correspond to a known touch shape area; and
causing the device to present an indication that the touch area shape has not been recognized if the touch shape area does not correspond to a known touch shape area.

45. At least one machine readable storage medium having stored thereon, individually or in combination, instructions for touch-based link initialization and data transfer that, when executed by one or more processors, cause the one or more processors to:
sense a gesture drawn on a surface of a display in a device;
identify the gesture;
sense a touch area shape associated with the gesture; and
control communications in the device based on the gesture and the touch area shape.

46. The medium of claim 45, wherein the instructions causing the one or more processors to identify the gesture comprise instructions causing the one or more processors to determine if the gesture corresponds to a known gesture for controlling how the device interacts with at least one other device.

47. The medium of claim 46, further comprising instructions that, when executed by the one or more processors, cause the one or more processors to:
determine that the gesture corresponds to a known gesture; and
cause the device to transmit a signal inviting wireless link establishment.

48. The medium of claim 46, further comprising instructions that, when executed by the one or more processors, cause the one or more processors to:
determine that the gesture corresponds to a known gesture; and
cause the device to transmit a signal advertising availability of the device to share at least one object.

49. The medium of claim 46, further comprising instructions that, when executed by the one or more processors, cause the one or more processors to:
determine that the gesture corresponds to a known gesture; and
cause the device to scan for a signal advertising availability of the at least one other device to share at least one object.

50. The medium of claim 46, further comprising instructions that, when executed by the one or more processors, cause the one or more processors to:
cause the device to present a confirmation request prior to allowing the device to interact with the at least one other device.
